(19) United States
(12) Patent Application Publication
(10) Pub. No.: US 2006/0230139 A1
(43) Pub. Date: Oct. 12, 2006

(54) Method and apparatus for running a test program in a computer system

(76) Inventor: David Locke, Chandlers Ford (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/393,928

(22) Filed: Mar. 30, 2006

(30) Foreign Application Priority Data
Apr. 8, 2005 (GB) 0507150.1

(51) Int. Cl. G06F 15/173

(52) U.S. Cl. 709/224

(57) ABSTRACT

Method and apparatus for running a test program for an element of a computer system by detecting idle processor cycles in a processor in the system, selecting a test program for an element of the computer system; and running the test program for the element on the processor in response to detection of idle processor cycles.

### FIELD OF THE INVENTION

The present invention relates to a method and apparatus for running a test program in a computer system.

### BACKGROUND

Testing computer systems is a complex task. Commonly, testing is carried out within a closed test environment to provide consistent test results. For example, the testing may be carried out on a set of dedicated test computers and may use a dedicated network.

Running tests in restricted networks does not take into account real conditions such as concurrent network use, network latency, or bandwidth fluctuations. Also, when running tests on dedicated hardware, it is difficult to take into account processing power, software interaction, or operating system performance which may be unpredictable in a runtime environment. Furthermore, it is difficult to simulate user interaction with a computer system within a test environment.

### SUMMARY

In one aspect, the invention provides a framework for testing a computer system which enables testing to be carried out within an operational computer system. The invention includes a method and apparatus for running a test program in a computer system.

One embodiment of the invention provides a method for running a test program for an element of a computer system that includes detecting idle processor cycles in a processor in the system; selecting a test program for an element of the computer system; and running the test program for the element on the processor in response to the detection of idle processor cycles. The method may also include displaying a screen saver in response to running the test program.

The method may comprise the further step of detecting demand for processor use from a program other than the test program and suspending the processing of the test program. The test program may be selected by sending a request to a test program provider. The request may include data describing the set-up of the computer for use by the test program provider in selecting the test program. The request may include an identifier for the computer for use by the test program provider in selecting the test program. The test program provider may use the identifier to identify the set-up of the computer and to use the set-up to select the test program. The method may comprise the further step of returning the results of the test program to the test program provider.

Another embodiment of the invention provides apparatus for running a test program for an element of a computer system. The apparatus may include an activity monitor operable to detect idle cycles of a processor in the system; a test program selector operable to select a test program for an element of the computer system; and a test manager operable to run the test program on the processor in response to the detection of idle cycles by the activity monitor. The activity monitor may be arranged identify spare processing capacity in the processor for use in running the test program.

Further embodiments of the invention provide a method of running a test program on a computer in a computer network. The method may include the steps of detecting idle processor cycles in a first computer in the network; selecting a test program for testing a second computer in the computer network; and running the test program on the first computer in response to the detection of idle processor cycles. The test program may be selected by a test program server in response to a request from the first computer and the results of running the test may be returned to the test program server.

Other embodiments of the invention provide apparatus for running a test program on a computer in a computer network. The apparatus may include an activity monitor for detecting idle cycles of a processor in a first computer in the network; and a test program selector operable to select one or more test programs for testing a second computer in the computer network; the first computer being operable in response to the detection of idle cycles by the activity monitor to run the one or more test programs selected by the test program selector.

Further embodiments of the invention provide apparatus for running a test program for an element of a computer system. The apparatus may include means for detecting idle processor cycles in a processor in the system; means for selecting a test program for an element of the computer system; and means for running the test program for the element on the processor in response to the detection of idle processor cycles.

Other embodiments of the invention provide a computer program or group of computer programs arranged to enable a computer or group of computers to carry out a method running a test program for an element of a computer system. The method may include the steps of: detecting idle processor cycles in a processor in the system; selecting a test program for an element of the computer system; and running the test program for the element on the processor in response to the detection of idle processor cycles.

Further embodiments of the invention provide a computer program or group of computer programs arranged to enable a computer or group of computers to provide apparatus for running a test program for an element of a computer system. The apparatus may include an activity monitor operable to detect idle cycles of a processor in the system; a test program selector operable to select a test program for an element of the computer system; and a test manager operable to run the test program on the processor in response to the detection of idle cycles by the activity monitor.

### BRIEF DESCRIPTION OF THE DRAWINGS

Embodiments of the invention will now be described, by way of example only, with reference to the accompanying drawings, in which:

FIG. 1 is a schematic illustration of a computer system;

FIG. 2 is a flow chart illustrating the operation of a client computer in the computer system of FIG. 1; and

FIG. 3 is a flow chart illustrating the operation of a test server computer in the computer system of FIG. 1.

### DETAILED DESCRIPTION

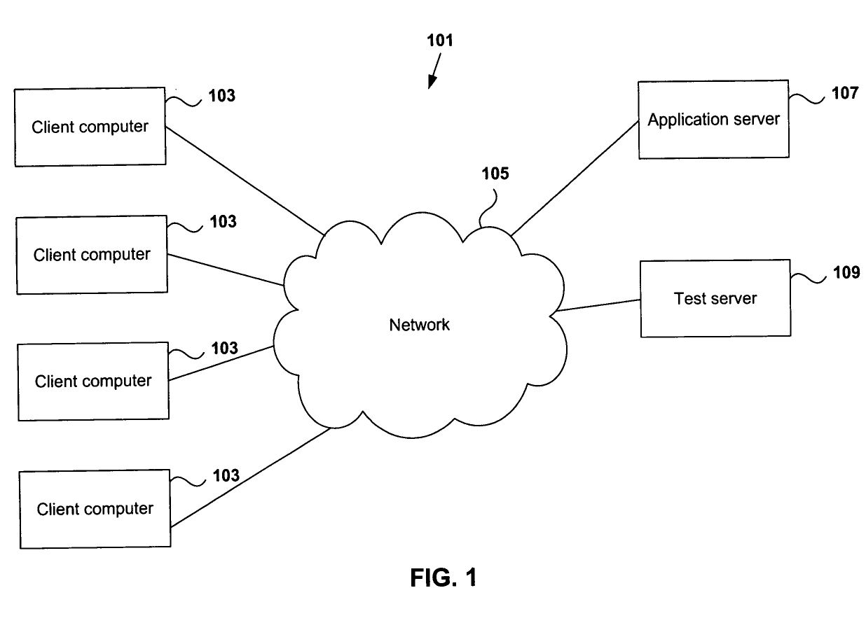

With reference to FIG. 1, a computer system 101 comprises client computers 103 connected over a network 105 to an application server 107 and a test program provider in the form of a test server 109. Each of the client computers 103 runs an operating system such as Linux™, Windows™ or MacOS™ and one or more application programs which access the server 107 over the network 105. The server 107 runs a Unix™ operating system and one or more application programs which provide services to the client computers 103 over the network 105.

In addition to the operating systems and application programs, each of the client computers 103 also comprises a test manager in the form of a test management program (TMP). The TMP uses a processor activity monitor to detect idle cycles of the processor of the client computer 103 on which it runs. Such idle cycles indicate that the client computer is not in use. In response to such detection, the TMP sends a request to the test server 109. The test server 109 is arranged to respond to such requests from client computers by providing a test program. The client computer uses its otherwise idle processor to run the received test program, and returns the generated test data to the test server 109. While the test program is run, the TMP has the option to display a screen saver on the client computer display. If the processor remains idle after the completion of a test program, the TMP sends a further request to the test server 109. If, during the running of the test program the use of the client computer processor (other than by the test program) is resumed either by the operating system or by an application program, the processing of the test program is suspended. When idle cycles are detected once more then the processing of the test program is resumed.

The request sent from the client to the test server 109 includes details of the client hardware, operating system and application programs. This data is used by the test server to select an appropriate test program to return to that client. The test programs provided by the test server 109 are arranged to carry out tests on the computer system 101 as a whole as well as the individual components or elements. The test programs are arranged so that multiple client computers can run test programs that send requests across a network to test any server connected to the network. Servers may include server farms or clusters or application servers or messaging servers. The test programs are arranged to cover the expected range of runtime environments by taking into account variations in operating system, processor, memory and application software versions. The test programs can also take into account the variations in network connectivity which may be encountered in a running computer system. For example, clients may be connected to the servers via different types of network technology such as Ethernet, token ring or wireless systems.

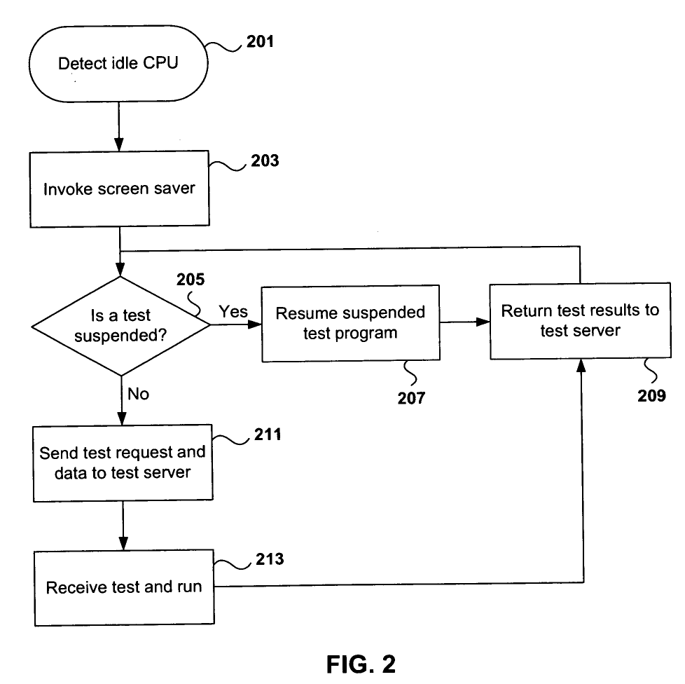

The processing carried out by the test management program (TMP) will now be described with reference to the flow chart of FIG. 2. At step 201 the activity monitor used by the TMP detects idle cycles in the processor of the client computer and processing moves to step 203 where, if configured, a screen saver is displayed on the client computer. Processing then moves to step 205 where a check is carried out to determine if a suspended or in-progress test program exists. If this is the case, then processing moves to step 207 where the processing of the suspended case is resumed and at step 209 the results of the completed test program are passed to the test server 109. It should be noted that the processing of FIG. 2 can be interrupted at any time by the resumption of normal processing by the processor, that is, processing other than that of the TMP. In this case any test program in progress is suspended until processing returns to step 207 when further idle cycles have been detected.

If no test program has been suspended at step 205, then processing moves to step 211 where a request is sent to the test server 109. The message sent to the test server includes details of the clients hardware and software set-up which is used by the test server to determine appropriate test programs to return to the client for execution. At step 213 a test program is received form the test server and executed by the TMP. Once the processing of the program is complete processing moves to step 209 where the results of the test program are returned to the test server. Processing then moves to step 205 and processing continues as described above.

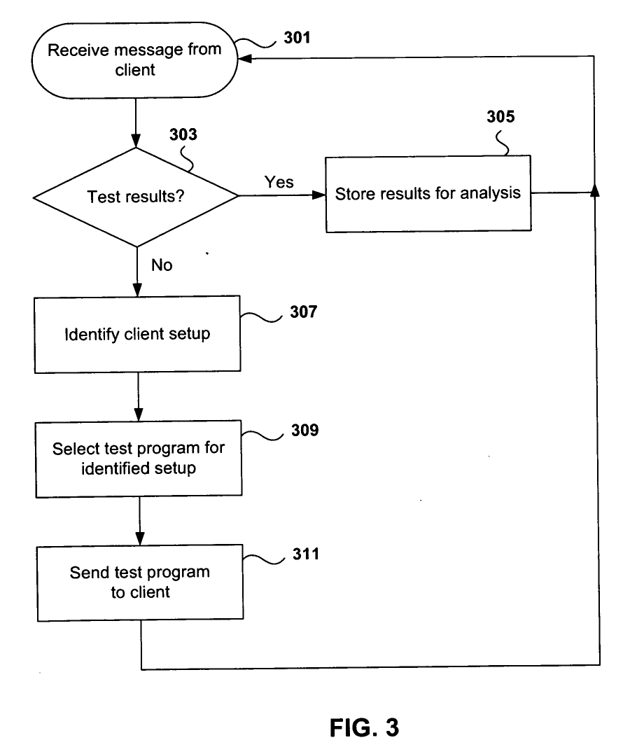

The processing carried out by the test server 109 when interacting with the client computers will now be described with reference to the flow chart of FIG. 3. At step 301, a message is received from a client computer and processing moves to step 303 where the message is inspected. If the message is a set of results from a completed test program then processing moves to step 305 where the test results are stored for further analysis, and processing returns to await further messages at step 301. If at step 303 the message is a request for a test program, then processing moves to step 307 where the set-up of the client computer is identified from the received data. At step 309 the client set-up data is used to select the appropriate test program to be sent to the client. At step 311 the test program is sent to the client computer for execution by the TMP as described above with reference to FIG. 2. Processing then returns to step 301 as described above.

In another embodiment, there is no screen saver facility as described above; instead, the client computer shows no outward sign that the TMP is in operation. In a further embodiment the detection of idle cycles is triggered when a screen saver is started by the operating system. The activation of the screen saver indicating idle processor cycles. In another embodiment the detection of idle cycles is carried out by monitoring a screen saver program itself. The TMP can then be run under the screen saver. In a further embodiment, a screen saver program is used to detect an idle system and to drive the TMP.

In a further embodiment, instead of the client providing set-up details to the test server, the client provides an identifier which enables the test server to identify the client in a database and from that database extract prestored set-up details for the client. In another embodiment, the TMP and the test server functionality are all provided on the same physical computer. In another embodiment, the computer system is not a client server computer system but another architecture such as peer to peer. In some embodiments the element of the computer system undergoing testing is an element such as a network switch or controller or storage device such as a disk drive array. In other words, the test subject or element can be any device in communication with the processor running the TMP and may be part of the computer of which the processor forms a part.

In the embodiments described above, the activity monitor is arranged to detect idle cycles in an associated CPU (central processing unit). In an alternative embodiment, the activity monitor is arranged to detect spare processor capacity in a multi CPU or a multithreading processor/operating system arrangement to enable such spare processing capacity to be utilized by the TMP to run test programs along with the other work that the processor is carrying out.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via various transmission or storage means such as computer network or any suitable data carrier such as a CD or DVD so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from spirit or scope of applicant's general inventive concept.

What is claimed is:

1. A method for running a test program for an element of a computer system, said method comprising:
detecting idle processor cycles in a processor in said system;
selecting a test program for an element of said computer system; and
running said test program for said element on said processor in response to detection of idle processor cycles.

2. A method according to claim 1, further comprising displaying a screen saver when running the test program.

3. A method according to claim 1, further comprising detecting demand for processor use from a program other than said test program and suspending processing of said test program.

4. A method according to claim 1, wherein said test program is selected by sending a request to a test program provider.

5. A method according to claim 4, wherein said request includes data describing the set-up of said computer for use by said test program provider in selecting said test program.

6. A method according to claim 4, wherein said request includes an identifier for said computer for use by said test program provider in selecting said test program.

7. A method according to claim 6, wherein said test program provider uses said identifier to identify the set-up of said computer and uses said set-up to select said test program.

8. A method according to claim 1, further comprising returning the results of said test program to said test program provider.

9. Apparatus for running a test program for an element of a computer system, said apparatus comprising:
an activity monitor operable to detect idle cycles of a processor in said system;
a test program selector operable to select a test program for an element of said computer system; and
a test manager operable to run said test program on said processor in response to said detection of idle cycles by said activity monitor.

10. Apparatus according to claim 9, being further operable to display a screen saver when said test program is run.

11. Apparatus according to claim 9, wherein said activity monitor is operable to detect demand for processor use from a program other than said test program and to suspend the processing of said test program.

12. Apparatus according to claim 9, wherein said test program selector is operable in response to a request for a test program from said test manager.

13. Apparatus according to claim 12, wherein said request includes data describing the set-up of said computer for use by said test program provider in selecting said test program.

14. Apparatus according to claim 12, wherein said request includes an identifier for said computer for use by said test program provider in selecting said test program.

15. Apparatus according to claim 14, wherein said test program provider uses said identifier to identify the set-up of said processor and to use said set-up to select said test program.

16. Apparatus according to claim 9, wherein said test manager is operable to return the results of said test program to said test program provider.

17. Apparatus according to claim 9, wherein said activity monitor is arranged to identify spare processing capacity in said processor for use in running said test program.

18. Apparatus for running a test program on a computer in a computer network, said apparatus comprising an activity monitor for detecting idle cycles of a first computer in said network and a test program selector operable to select one or more test programs for testing a second computer in said computer network, wherein said first computer is operable in response to the detection of idle cycles by said activity monitor to run said one or more test programs selected by said test program selector.

19. Apparatus according to claim 18, wherein said test program selector is operable to request and receive said one or more test programs from a test program server and to return the results of running said one or more tests to said test program server.

20. A computer program product for running a test program for an element of a computer system, said computer program product comprising a computer readable medium having computer readable program code tangibly embedded therein, the computer readable program code comprising:
computer readable program code configured to detect idle processor cycles in a processor in said system;
computer readable program code configured to select a test program for an element of said computer system; and
computer readable program code configured to run said test program for said element on said processor in response to detecting idle processor cycles.
